(19) United States
(12) Patent Application Publication
(10) Pub. No.: US 2017/0150148 A1
(43) Pub. Date: May 25, 2017

(54) IMAGE COMPRESSION METHOD AND APPARATUS

(71) Applicant: Xiaomi Inc., Beijing (CN)

(72) Inventors: Tao Zhang, Beijing (CN); Zhijun Chen, Beijing (CN); Fei Long, Beijing (CN)

(73) Assignee: Xiaomi Inc., Beijing (CN)

(21) Appl. No.: 15/240,498

(22) Filed: Aug. 18, 2016

(30) Foreign Application Priority Data
Nov. 23, 2015 (CN) 201510815633.2

(51) Int. Cl. H04N 19/124; H04N 19/176; H04N 19/167; H04N 19/18; G06T 7/00; H04N 19/625

(52) U.S. Cl. CPC H04N 19/124; G06T 7/0081; H04N 19/625; H04N 19/167; H04N 19/18; H04N 19/176; G06T 2207/20021

(57) ABSTRACT

Method and device are disclosed for image compression. An input image is processed and divided into regions of interest (ROIs) and non-ROIs. The quantization parameters for quantizing the DCTs of image blocks from ROIs and non-ROIs are separately determined based on a predetermined percentage of sum of low frequency pre-quantized DCT components over sum of all pre-quantized DCT components, where the division of high and low frequency is made based on the boundary of zero and nonzero components of quantized DCT matrix.

### IMAGE COMPRESSION METHOD AND APPARATUS

This application claims priority from the Chinese patent application No. 201510815633.2, filed on Nov. 23, 2015, which is incorporated herein by reference in its entirety.

### TECHNICAL FIELD

The present disclosure is related to the field of computer technologies, and more particularly, to image compression.

### BACKGROUND

Cloud storage gradually becomes an important storage choice for people. Users can store and manage their data in the cloud via a terminal device. For example, the users can upload photos from mobile phones to the cloud for back-up.

However, as more and more photos are stored in the cloud, image compression technologies that reduce the image storage space while still maintain image quality becomes critical. The JPEG (Joint Photographic Experts Group) compression in the related art may reduce the image storage space but may also reduce image quality at the same time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, an image compression method is disclosed. The method includes acquiring an uncompressed source image; dividing the source image into at least two regions of pixels; dividing the source image into blocks of pixels of a preset size, and converting data in each pixel block into frequency-domain data; determining quantization tables each corresponding to each region, wherein different quantization tables for different regions correspond to different quantization parameters; quantizing the frequency-domain data of pixel blocks in each region by using the corresponding quantization table; and encoding the quantized frequency-domain data to obtain a compressed image.

In another embodiment, a terminal device is disclosed. The terminal device includes a processor and a memory configured to store instructions executable by the processor, wherein the processor is configured to cause the device to: acquire an uncompressed source image; divide the source image into at least two regions of pixels; divide the source image into blocks of pixels of a preset size, and convert data in each pixel block into frequency-domain data; determine quantization tables each corresponding to each region, wherein different quantization tables correspond to different quantization parameters; quantize the frequency-domain data of the pixel blocks in each region by using the corresponding quantization table; and encode the quantized frequency-domain data to obtain a compressed image.

In yet another embodiment, a non-transitory computer-readable storage medium having stored therein instructions is disclosed. The instructions, when executed by a processor of a mobile terminal, cause the mobile terminal to acquire an uncompressed source image; divide the source image into at least two regions of pixels; divide the source image into blocks of pixels of a preset size, and converting data in each pixel block into frequency-domain data; determine quantization tables each corresponding to each region, wherein different quantization tables correspond to different quantization parameters; quantizing the frequency-domain data of the pixel blocks in each region by using the corresponding quantization table; and encode the quantized frequency-domain data to obtain a compressed image.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing an image compression method according to an exemplary embodiment.

FIG. 2 is a flow chart showing another image compression method according to an exemplary embodiment.

FIG. 3A is a flow chart showing the determination of an ROI and a non-ROI according to an exemplary embodiment.

FIG. 3B shows an exemplary image containing ROIs and non-ROIs.

FIG. 4 is illustrates the division of an image into pixel blocks according to an exemplary embodiment.

FIG. 5 is a schematic drawing showing the Zig-Zag encoding path according to an exemplary embodiment.

FIG. 6 is a flow chart showing another image compression method according to an exemplary embodiment.

FIG. 7 is a block diagram of an image compression apparatus according to an exemplary embodiment.

FIG. 8 is a block diagram of the first division module 120 of FIG. 7.

FIG. 9 is a block diagram of an apparatus for image compression according to an exemplary embodiment.

FIG. 10 is a block diagram of another apparatus for image compression according to an exemplary embodiment.

Through the above accompany drawings, the specific embodiments of the disclosure have been shown, for which more detailed description will be given as below. These drawings and textual description are not intended to limit the scope of the concept of the disclosure in any manner, but to explain the concept of the disclosure to those skilled in the art through particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The terms used herein are merely for describing a particular embodiment, rather than limiting the present disclosure. As used in the present disclosure and the appended claims, terms in singular forms such as “a”, “said” and “the” are intended to also include plural forms, unless explicitly dictated otherwise. It should also be understood that the term “and/or” used herein means any one or any possible combination of one or more associated listed items.

It should be understood that, although it may describe an element with a term first, second, or third, etc., the element is not limited by these terms. These terms are merely for distinguishing among elements of the same kind. For example, without departing from the scope of the present disclosure, a first element can also be referred to as a second element. Similarly, a second element can also be referred to as a first element. Depending on the context, a term “if” as used herein can be interpreted as “when”, “where” or “in response to that”.

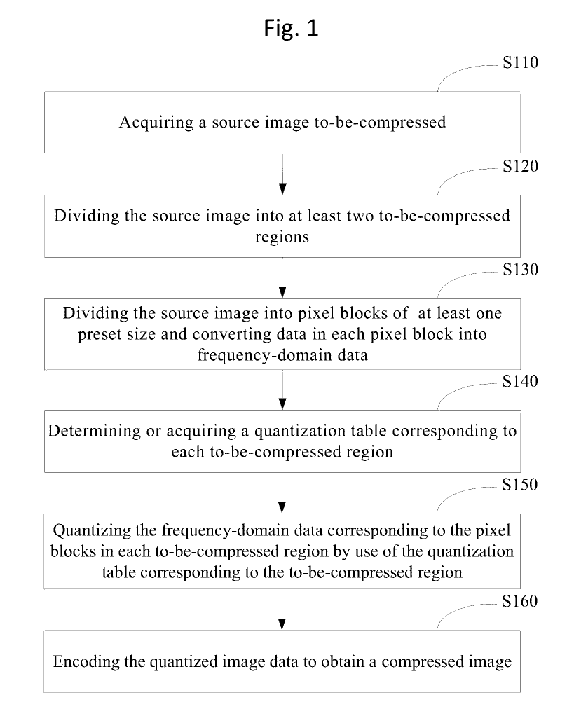

FIG. 1 is a flow chart showing an image compression method according to an exemplary embodiment. The method may be applied to a terminal device or a cloud server.

In Step S110, the terminal or the server acquire a source image to-be-compressed. The source image may be uncompressed and may comprise, e.g., RGB values, each for each pixel of the image. In one scenario, the source image may be processed by the terminal and may need to be uploaded to the server. Thus the terminal may compress the source image before it is uploaded to the server, advantageously reducing communication bandwidth required. In the meanwhile, because the compressed image may be significantly smaller in file size, compressing image for storage in the cloud helps relieving pressure on the storage space. In another scenario, the source image may be a picture stored locally in the terminal device, and after the method provided by this embodiment is utilized for image compression, the storage space requirement of the terminal device is reduced.

In Step S120, the terminal or the server divides the source image into at least two to-be-compressed regions. Specifically, target objects may be identified from the source image at first, then the source image may be segmented according to the identified target objects. Various imaging processing algorithms exist in the art for identification of various target objects, such as a human character, an animal, and a landscape object. All regions obtained from segmentation are separate to-be-compressed regions. Each region may be of any shape and contain any number of pixels. Each region may contain one or more identified adjacent target objects. The number of the divided regions to to-be-compressed is related to the number and the positions of the target objects and non-target objects in the source image. The more dispersed the target objects are, the larger the number of regions is. Some of these regions may be regions of interest. For example, an image may be characterized as a portrait of a person using imaging processing techniques and the region contain the face of the person may be determined as a region of interest (ROI).

In Step S130, the terminal or server divides the source image into pixel blocks of a preset size and converting or transforming data in each pixel block into frequency-domain data. For example, data in each pixel block may be subject to DCT (Discrete Cosine Transform) which converts an array of pixel data in space to a spatial frequency domain (herein referred to as frequency domain). Generally, the terminal or server may divide an image into multiple N×N pixel blocks and conducts DCT operation on each N×N pixel block, wherein N is the number of pixels of a block in horizontal and vertical directions. For example, N may be 8. That is, the source image may be divided into blocks of 8×8 pixels. The output of the DCT of an N×N pixel data array may be another N×N array in frequency-domain. DCT may be performed separately for each channel of RGB data of the image. Although a single block size is used in the exemplary embodiment of FIG. 1, variable-size blocks within an image are contemplated. Further, it is preferable that the contour of the regions runs along block boundaries.

In Step S140, the terminal or server determines a quantization table corresponding to each to-be-compressed region. Each quantization table may be a collection of quantization parameters that determines a degree of compression and compression losses. In the present embodiment, the quantization table for each region may be separately determined and may be different, representing different degree of compression and different compression loss for different regions. Specifically, each to-be-compressed region is quantized using the correspondingly determined quantization table having corresponding quantization parameters. The larger the quantization parameters, the fuzzier an compressed region is, and in the contrary, the smaller the quantization parameters are, the more details the compressed region retains.

In Step S150, the terminal or the server quantizes the frequency-domain data corresponding to the pixel blocks in each to-be-compressed region by using the determined quantization table corresponding to the to-be-compressed region.

In Step S160, the terminal or the server encodes the quantized image data for all to-be-compressed regions to obtain a compressed image.

Thus, according to the image compression method provided by the embodiment of FIG. 1, the to-be-compressed source image is acquired and divided into at least two to-be-compressed regions. The source image is divided into pixel blocks of preset sizes, and data in each pixel block are converted into frequency-domain data. A quantization table corresponding to each to-be-compressed region is determined or acquired. Different regions may be compressed by different quantization tables corresponding to different sets of quantization parameters. Each to-be-compressed region may be quantized by using the determined corresponding quantization table. Quantization tables with relatively small quantization parameters may be used for some more important to-be-compressed regions, so as to retain more detailed information. On the other hand, quantization tables with relatively large quantization parameters may be used by other less important to-be-compressed regions, so as to greatly reduce the image storage space while maintaining quality for the more important regions. By utilizing the image compression method above, not only is the image quality of some regions guaranteed, but also the image storage space is greatly reduced.

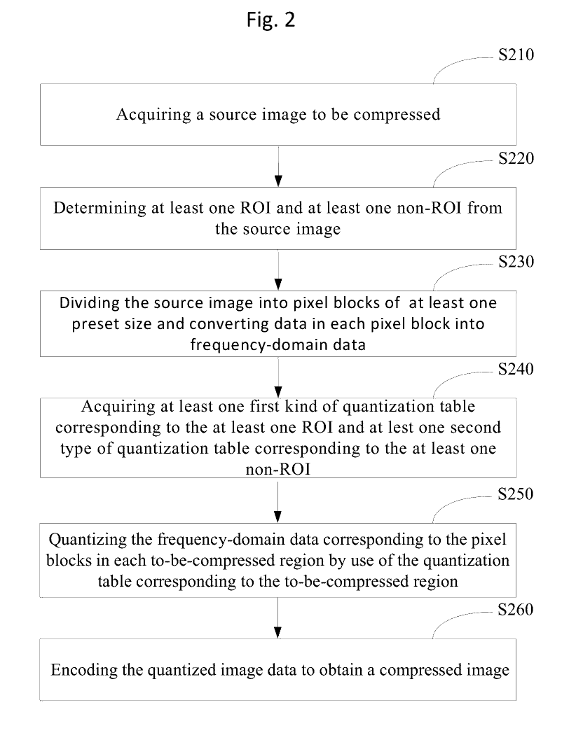

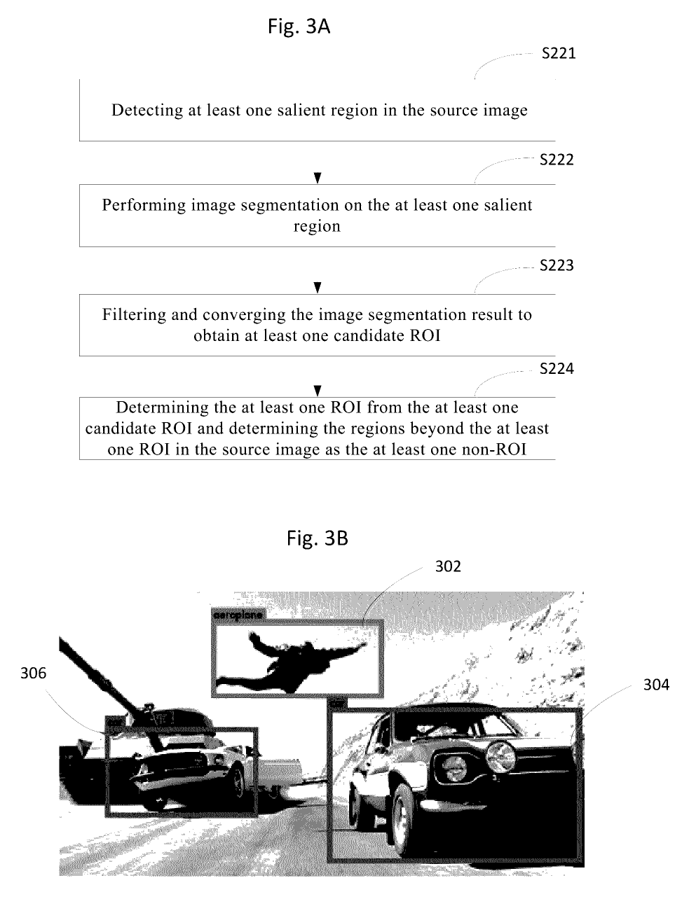

FIG. 2 is a flow chart showing another image acquiring method according to a more detailed exemplary embodiment. As shown in FIG. 2, the method may comprise the steps as follows. In Step S210, the terminal or the server acquires a to-be-compressed source image. In step S220, the terminal or the server determining at least one ROI and at least one non-ROI in the source image. Specifically, an ROI and non-ROI in the source image may be identified by an ROI detection algorithm that may determine an outline of a region having contents of interest with any shape such as square, circle, ellipse, and irregular polygon, etc. The ROI detection algorithm may be based on machine vision and image processing (such as face-recognition). For example, ROI may be identified based on edge detection. ROI identification may be based on machine learning. Further, ROI may be hierarchical with layered objects of various degrees of interest. An ROI potentially contains more important objects of the source image and its identification facilitates further image processing by shortening the image processing time and improving image processing precision. There may be multiple ROIs in an image. FIG. 3A is a flow chart showing an exemplary embodiment for the determination of an ROI and a non-ROI comprising steps S221-S224.

In Step S221, the terminal or the server detects a salient region in the source image where the salient region may be a region in the source image having abrupt color changes. In Step S222, the terminal or the server performs image segmentation within the salient region. Specifically, image segmentation is a technology and process that divides an image or a region of an image into a plurality of specific regions with distinct properties and identifies targets or objects that may be of interest. K-means algorithm is an example of image segmentation technology. In Step S223, the terminal or server filters and converges the image segmentation result to obtain at least one candidate ROI. In Step S224, the terminal or the server determines at least one ROI from the at least one candidate ROI, and determining the region beyond the ROI in the source image as the non-ROI.

FIG. 3B shows an exemplary image have regions of abrupt color changes. For example, the region 302 has abrupt boundary between the human character and its background and may be determined as one of the candidate ROIs using K-means algorithm. Similarly, other regions such as 304 and 306 have abrupt color changes and may be determined as other candidate ROIs. The terminal may determine one or more of the three candidate ROIs as ROIs for further processing and the rest of the image as non-ROI.

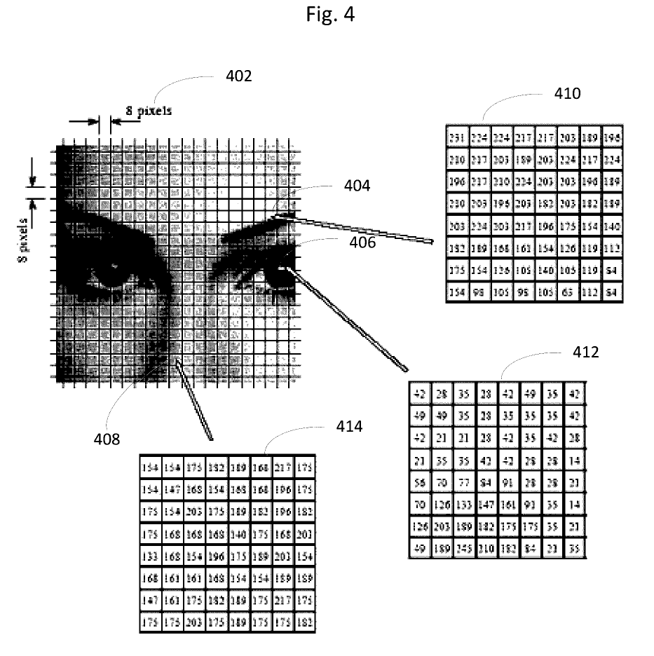

Returning to FIG. 2 and in Step S230, the terminal or server divides the source image into pixel blocks of at least one preset size and converting data in each pixel block into frequency-domain data, similar to Step S130 of FIG. 1. FIG. 4 illustrates a division of an image into pixel blocks according to an exemplary embodiment. Specifically, the original image is divided into a plurality of 8×8 pixel blocks, as indicated by 402. Frequency-domain data (Y channel of YCbCr is taken as an example) corresponding to three of the pixel blocks, 404, 406 and 408, are shown in tables 410, 412, and 414 respectively. Generally, an 8×8 conversion frequency coefficient matrix is obtained after an 8×8 two-dimensional pixel block is subject to DCT. Each coefficient has specific physical meaning. For example, when U=0 and V=0, F (0, 0) is the mean value of the original 64 data in space, equal to a DC component also known as a DC coefficient. Here, F(U, V) is the frequency-domain coefficient matrix and U and V are the matrix indices. With increase of U and V, other 63 coefficients represent the values of non-DC horizontal spatial frequency and vertical spatial frequency components, and most of the 63 coefficients are positive and negative floating point numbers also known as AC coefficients. Division of low and high frequency components may be predefined. For example, low frequency components may only include the DC component and high frequency components may correspondingly comprise all the 63 AC components. Alternatively, low frequency components may include the DC component and other AC components with matrix indices less than a predefined integer, e.g., 1 or 2 or 3. In an 8×8 DCT coefficient matrix, low-frequency components are located at or near the upper left corner of the matrix shown by 410, 412 and 414, while the high-frequency components are centralized away from the upper left corner and towards the lower right corner of the matrix.

Returning again to FIG. 2 and in Step S240, the terminal or server determines and acquires at least one first type of quantization tables corresponding to the at least one ROI and at least one second type of quantization table corresponding to the at least one non-ROI. Because a non-ROI is of less interest and thus may be subject to greater compression loss, the quantization parameters in the at least one second quantization table may be larger (thus the resulting quantization will be coarser) than those of the first type of quantization tables.

Specifically, the quantization parameters corresponding to high-frequency part in the first type of quantization tables are determined according to frequency-domain values of the corresponding high-frequency components in the pixel blocks of the ROI and a preset percentage. These quantization parameters for blocks in ROI is set such that the sum of all low frequency matrix elements of the average DCT matrix of all original DCT matrices of all blocks of the ROI over the sum of all matrix elements of the average original DCT matrix of all blocks of the ROI equals or is higher than the preset percentage. The division of low and high frequency DCT matrix elements is determined by the average quantized DCT matrix of all quantized DCT matrices using the quantization parameters. Specifically, all non-zero elements of the average quantized DCT matrix may be considered low frequency and the zero elements may be considered high frequency. Thus, the quantization parameter may be recursively set in one implementation. For example, the preset percentage may be 60%.

Similarly, the quantization parameters in the second kind of quantization tables are determined according to the frequency-domain values in the pixel blocks in the non-ROI and a corresponding preset percentage. The percentage for the non-ROI is preferably higher than the percentage for ROIs such that there are less fewer non-zero components in the non-ROI after quantization.

It should be noted that the same or different quantization tables can be used for different ROIs. Similarly, the same or different quantization tables can also be used for different non-ROIs. However, the values at the lower right corners in the quantization tables corresponding to the non-ROIs are preferably larger than values at corresponding positions in the quantization tables of the ROIs.

In some other implementation, the ROI may be ranked into multiple layers according to the degrees of interest of various regions. Quantization parameters for different layers of ROIs may be set differently. For example, quantization parameters for different layers of ROIs may be set based on the principles described above. Specifically, the predetermined percentage described above may be set differently for different layers. The higher the layer is ranked according to level of interest, the lower the percentage and thus more DCT matrix elements are quantized to non-zero values.

In Step S250, the terminal or server quantizes the frequency-domain data corresponding to the pixel blocks in each to-be-compressed region (ROI or non-ROI) by use of the corresponding quantization table. Quantization is performed by dividing each DCT coefficient by the corresponding matrix value (the corresponding quantization parameter) of the quantization tables. As for the 8×8 pixel blocks, correspondingly, the quantization tables are also 8×8 matrices. Thus, the DCT coefficients of each block are divided by the quantization parameters at the corresponding matrix positions in the quantization tables to obtain the quantization result, which is also an 8×8 matrix. Each matrix element (each quantization parameter) of a quantization table effectively helps reduce the discrete levels available for each corresponding DCT coefficient. The greater the quantization matrix element, the few the available levels (the more losses in compression but with greater degree of compression).

The parts of an image with drastic brightness or color changes, such as edges of objects, have more high-frequency DCT components which mainly measure the image edges and contours, while parts with little changes, e.g., blocks with uniform brightness and color, have more low-frequency DCT components. Therefore, the low-frequency components are more important than the high-frequency components because they capture overall smooth features in the image from block to block. As a result, the low frequency DCT components are preferably quantized more finely with smaller quantization parameters. As the low-frequency components are at the upper left corner of the DCT matrix corresponding to each pixel blocks while the high-frequency components are away from the upper left corner and towards the lower right corner, the values at the upper left corners of the quantization tables are relatively small and the values at the lower right corners are relatively large. Accordingly, the purposes of maintaining the low-frequency components at higher precision and quantizing the high-frequency components in a coarser way may be achieved.

ROIs are parts that are of interest in the source image, such as foreground objects in the image, whereas the non-ROIs are parts of less interest in the source image, such as background of the images. Therefore, the image sharpness of the ROIs should be maintained better than Non-ROIs after compression.. Based on the above, blocks in an ROI may use quantization tables with relatively small quantization parameters, whereas blocks in a non-ROI may use quantization tables with relatively large quantization parameters.

Table 1 shows an original pixel data matrix (channel Y of YbCbCr) for an exemplary block in an ROI according to an exemplary embodiment. Table 2 shows the corresponding matrix obtained after DCT of the pixel values in Table 1. Table 3 shows the quantization result of the Y channel DCT of the exemplary block.

TABLE 1

| | | | | | | | |
|---|---|---|---|---|---|---|---|
| 231 | 224 | 224 | 217 | 217 | 203 | 189 | 196 |
| 210 | 217 | 203 | 189 | 203 | 224 | 217 | 224 |
| 196 | 217 | 210 | 224 | 203 | 203 | 196 | 189 |
| 210 | 203 | 196 | 203 | 182 | 203 | 182 | 189 |
| 203 | 224 | 203 | 217 | 196 | 175 | 154 | 140 |
| 182 | 189 | 168 | 161 | 154 | 126 | 119 | 112 |
| 175 | 154 | 126 | 105 | 140 | 105 | 119 | 84 |
| 154 | 98 | 105 | 98 | 105 | 63 | 112 | 84 |

TABLE 2

| | | | | | | | |
|---|---|---|---|---|---|---|---|
| 174 | 19 | 0 | 3 | 1 | 0 | −3 | 1 |
| 52 | −13 | −3 | −4 | −4 | −4 | 5 | −8 |
| −18 | −4 | 8 | 3 | 3 | 2 | 0 | 9 |
| 5 | 12 | −4 | 0 | 0 | −5 | −1 | 0 |
| 1 | 2 | −2 | −1 | 4 | 4 | 2 | 0 |
| −1 | 2 | 1 | 3 | 0 | 0 | 1 | 1 |
| −2 | 5 | −5 | −5 | 3 | 2 | −1 | −1 |
| 3 | 5 | −7 | 0 | 0 | 0 | −4 | 0 |

TABLE 3

| | | | | | | | |
|---|---|---|---|---|---|---|---|
| 10 | 1 | 0 | 0 | 0 | 0 | 0 | 0 |
| 4 | 0 | 0 | 0 | 0 | 0 | 0 | 0 |
| 0 | 0 | 0 | 0 | 0 | 0 | 0 | 0 |
| 0 | 0 | 0 | 0 | 0 | 0 | 0 | 0 |
| 0 | 0 | 0 | 0 | 0 | 0 | 0 | 0 |
| 0 | 0 | 0 | 0 | 0 | 0 | 0 | 0 |
| 0 | 0 | 0 | 0 | 0 | 0 | 0 | 0 |
| 0 | 0 | 0 | 0 | 0 | 0 | 0 | 0 |

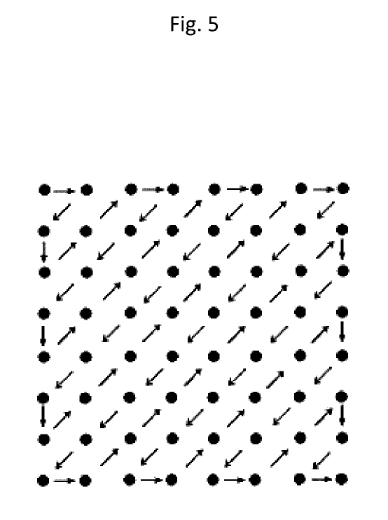

In Step S260, the terminal or server encodes the quantized image data to obtain a compressed image. Specifically, quantized DCT data is divided into two groups for encoding. The first group includes all elements at [0, 0] in the 8×8 quantized matrices (DC coefficients representing the mean pixel value of 8×8 blocks). The [0, 0] components of all blocks are independently encoded from other components. For example, in JPEG, as difference between the DC coefficients of adjacent 8×8 blocks is often very small, differential encoding DPCM is adopted to improve the compression ratio. That is, the quantized DC components are encoded by the small difference value of the DC coefficients of the adjacent sub-blocks (small values require fewer bits to represent). In the other group, other 63 quantized components in each 8×8 quantization result matrix, namely AC coefficients, may be encoded using RLE (Run-length encode). In order to ensure that low-frequency components appear before high-frequency components to increase the number of continuous ‘0’ in an encoding path, the 63 elements are encoded in the Zig-Zag order as shown in FIG. 5, starting from the upper-left (low frequency) corner and progressing to the lower-right corner.

In order to further improve the compression ratio, entropy encoding of the RLE result is performed, for example, Huffman encoding may be selected.

After encoding according to the embodiments above, more detailed information can be retained in the ROI of the obtained image, and meanwhile, the non-ROI may be compressed more aggressively.

Thus, according to the image compression method provided by the embodiment of FIG. 2, during image compression, the ROI and non-ROI are quantized by quantization tables with different quantization parameters. Specifically, the ROI adopts quantization tables with relatively small quantization parameters. That is, the values in the quantization tables are relatively small. The non-ROI adopts quantization tables with relatively large quantization parameters. That is, the values in the quantization tables are relatively large. After such treatment, more detailed information can be retained in an ROI of the image, and meanwhile, the non-ROI of the image is greatly compressed. The image compression method helps maintain the image quality of the ROI while reducing the required image storage space.

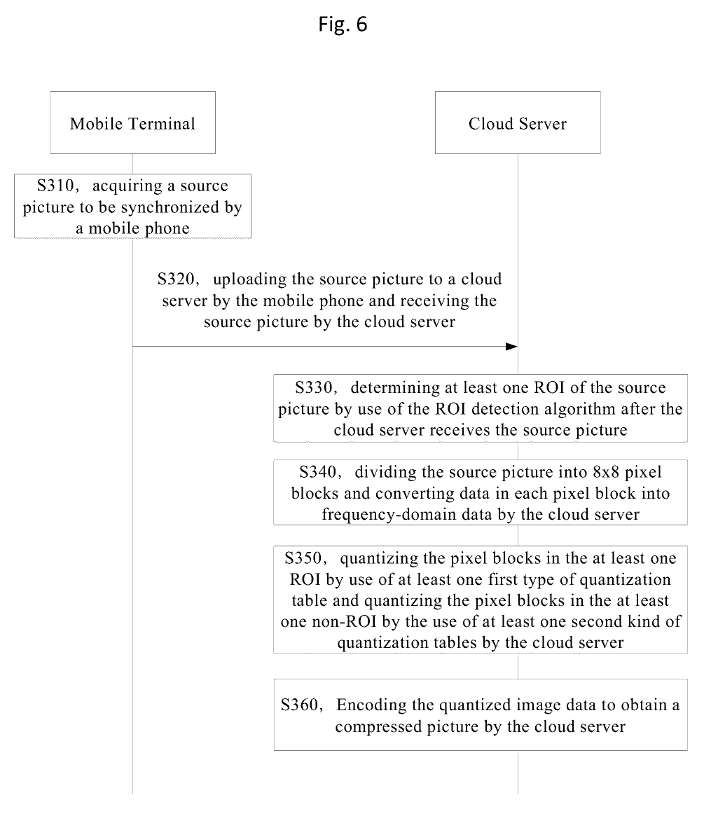

FIG. 6 is a flow chart showing another image compression method according to an exemplary embodiment. In the embodiment, a server conducts image compression. In Step S310, the terminal acquires a target picture to be synchronized in the cloud by a mobile phone or mobile terminal. In Step S320, the server in the cloud receives the source picture uploaded by the mobile phone. In Step S330, the server determines a ROI of a source picture by use of the ROI detection algorithm after the cloud server receives the target picture. In Step S340, the server divides the source picture into N×N pixel blocks and converting data in each pixel block into frequency-domain. In Step S350, the server quantizes the pixel blocks in the ROI by using the first type of quantization tables and quantizes the pixel blocks in the non-ROI by using the second type of quantization tables, wherein quantization parameters of the first type of quantization tables are smaller than those of the second type of quantization tables. In Step S360, the server encodes the quantized frequency-domain data to obtain a compressed image.

The image compression method provided by this embodiment is completed by the server with more powerful computing resources, so that the time required for picture compression is shortened. In addition, the mobile terminal is relieved from performing the compression and thus power consumption of the mobile device is decreased.

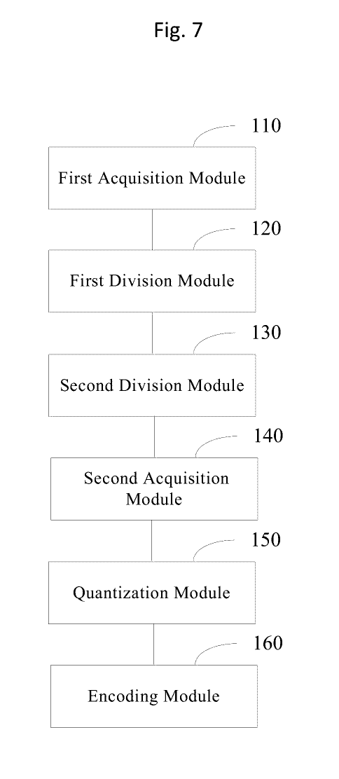

FIG. 7 is a block diagram showing an image compression device according to an exemplary embodiment, and the image compression device provided by this embodiment may be applied in a terminal device or a cloud server. As shown in FIG. 7, the image compression device may comprise a first acquisition module 110, a first division module 120, a second division module 130, a second acquisition module 140, a quantization module 150 and an encoding module 160. The first acquisition module 110 is configured to acquire a to-be-compressed source image. The source image may be a picture to be uploaded to the server or a picture stored locally in the terminal device. The first division module 120 is configured to divide the source image acquired by the first acquisition module 110 into at least two to-be-compressed regions.

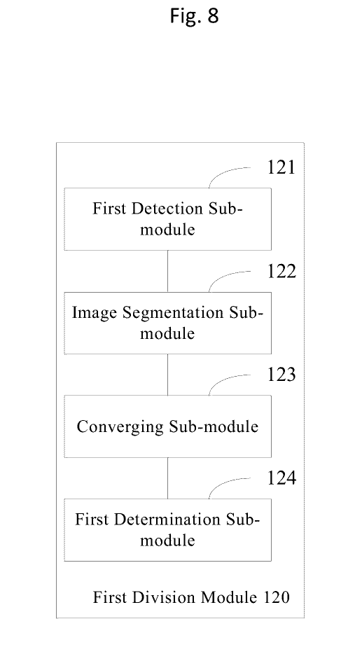

The first division module may divide the source image into a ROI and a non-ROI by use of the ROI detection algorithm. FIG. 8 is a block diagram of an exemplary implementation of the first division module. Specifically, the first division module 120 comprises a first detection sub-module 121, an image segmentation sub-module 122, a converging sub-module 123 and a first determination sub-module 124. The first detection sub-module 121 is configured to detect a salient region in the source image. The image segmentation sub-module 122 is configured to perform image segmentation on the detected salient region. The converging sub-module 123 is configured to filter and converge an image segmentation result to obtain at least one candidate ROI. The first determination sub-module 124 is configured to determine the ROI from the at least one candidate ROI, and determine the region beyond the ROI in the source image as the non-ROI.

Returning to FIG. 7, the second division module 130 is configured to divide the source image acquired by the first acquisition module 110 into pixel blocks of preset sizes and convert data in each pixel block into frequency-domain. The second division module is configured to divide the integral image into N×N pixel blocks, wherein N is the number of pixels in the horizontal and vertical directions and is generally 8. That is, 8×8 pixel blocks are obtained. Then, data transformation operation, such as DCT, of the N×N pixel blocks is performed block by block.

The second acquisition module 140 is configured to determine or acquire a quantization table corresponding to each to-be-compressed region obtained by the first division module 120, wherein different quantization tables correspond to different quantization parameters. Specifically, the second acquisition module may be configured to acquire a first type of quantization tables corresponding to the ROI and acquire a second type of quantization tables corresponding to the non-ROI, wherein the quantization parameters of the second kind of quantization tables are larger than those of the first kind of quantization tables. The quantization values corresponding to high-frequency parts in the first kind of quantization tables are determined according to the values of high-frequency components in the pixel blocks of the ROI and a preset percentage, wherein the preset percentage is a proportion of non-zero values in the quantization result and can be set as required by a user. The quantization values in the second kind of quantization tables are determined according to the DCT values in the non-ROI blocks and another preset percentage.

The quantization module 150 is configured to quantize the frequency-domain data corresponding to the pixel blocks in each to-be-compressed region by use of the quantization table corresponding to the to-be-compressed region. Quantization is the result of dividing DCT components by values corresponding to the quantization tables. As for the 8×8 pixel blocks, correspondingly, the quantization tables also adopt 8×8 matrices, and DCT components are divided by the values at the corresponding matrix positions in the quantization tables to obtain the quantization result, which is also a 8×8 matrix.

The encoding module 160 is configured to encode image data quantized by the quantization module 150 to obtain a compressed image.

According to the image compression apparatus provided by the embodiment of FIG. 7, the to-be-compressed source image is acquired and divided into at least two to-be-compressed regions. The source image is divided into the pixel blocks of preset sizes, and data in each pixel block are converted into frequency-domain data. The quantization table corresponding to each to-be-compressed region is determined or acquired. Different quantization tables correspond to different quantization parameters. Different to-be-compressed regions can be quantized by use of the quantization tables with different quantization parameters. Quantization tables with relatively small quantization parameters are used by some to-be-compressed regions, so as to retain more detailed information; and quantization tables with relatively large quantization parameters are used by other to-be-compressed regions, so as to greatly reduce the image storage space. By utilizing the image compression apparatus above for image compression, not only is the image quality of critical regions maintained, the required image storage space is also reduced.

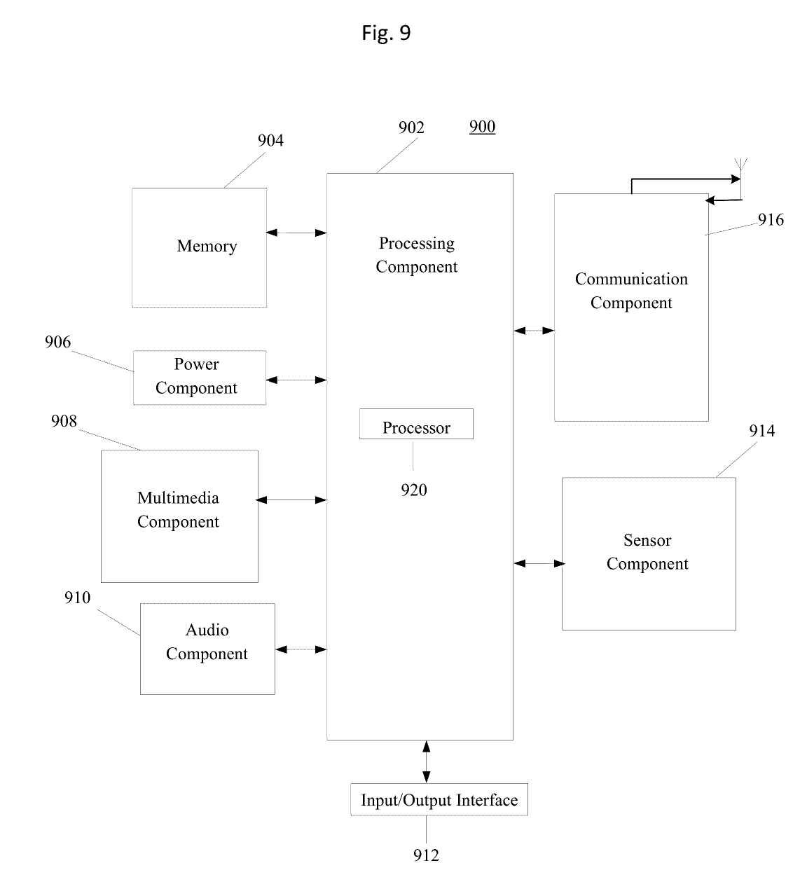

FIG. 9 is a block diagram of an apparatus 900 for image compression according to an exemplary embodiment. Fox example, the apparatus 900 may be a mobile phone, a computer, a digital broadcast terminal, a message transceiver, a game console, a tablet device, a medical device, fitness equipment, a personal digital assistant, or the like.

Referring to FIG. 9, the apparatus 900 may include one or more following components: a processing component 902, a memory 904, a power component 906, a multimedia component 908, an audio component 910, an input/output (I/O) interface 912, a sensor component 914 and a communication component 916.

The processing component 902 controls overall operations of the apparatus 900, such as the operations associated with display, telephone calls, data communications, camera operations and recording operations. The processing component 902 may include one or more processors 920 to execute instructions to perform all or part of the steps in the above described methods. Moreover, the processing component 902 may include one or more modules which facilitate the interaction between the processing component 902 and other components. For example, the processing component 902 may include a multimedia module to facilitate the interaction between the multimedia component 908 and the processing component 902.

The memory 904 is configured to store various types of data to support the operation of the apparatus 900. Examples of such data include instructions for any applications or methods operated on the apparatus 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the apparatus 900. The power component 906 may include a power supply management system, one or more power sources, and any other components associated with the generation, management, and distribution of power in the apparatus 900.

The multimedia component 908 includes a display screen providing an output interface between the apparatus 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and/or the rear camera may receive an external multimedia datum while the apparatus 900 is in an operation mode, such as a photographing mode or a video mode. Each of the front and rear cameras may be a fixed optical lens system or have a focus and optical zoom capability.

The audio component 910 is configured to output and/or input audio signals. For example, the audio component 910 includes a microphone (MIC) configured to receive an external audio signal when the apparatus 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the apparatus 900. For instance, the sensor component 914 may detect an open/closed status of the apparatus 900, relative positioning of components, e.g., the display and the keypad, of the apparatus 900, a change in position of the apparatus 900 or a component of the apparatus 900, a presence or absence of user's contact with the apparatus 900, an orientation or an acceleration/deceleration of the apparatus 900, and a change in temperature of the apparatus 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor or a temperature sensor or thermometer.

The communication component 916 is configured to facilitate communication, wired or wirelessly, between the apparatus 900 and other apparatuses. The apparatus 900 can access a wireless network based on a communication standard, such as WiFi, 2G, 3G, LTE or 4G cellular technologies, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium comprising instructions, such as comprised in the memory 904, executable by the processor 920 in the apparatus 900, for performing the above—described methods. For example, the non-transitory computer-readable storage medium may be a ROM, a RAM, a CD-ROM, a magnetic tape, a floppy disc, an optical data storage device, and the like.

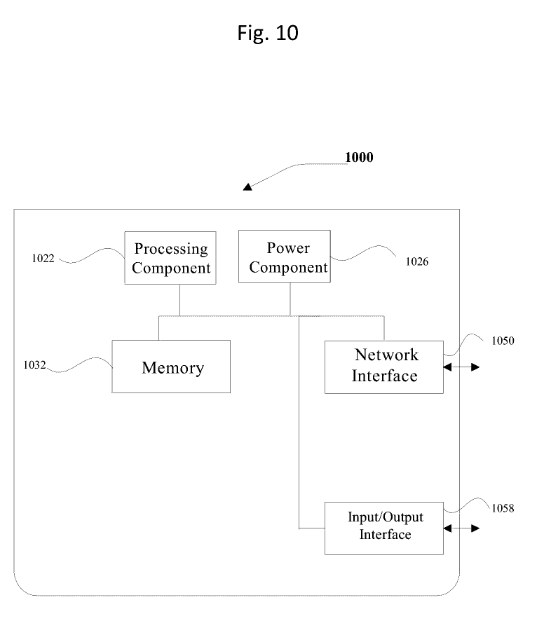

FIG. 10 is a block diagram of an apparatus 1000 for image compression according to an exemplary embodiment. For example, the device 1000 may be a server. Referring to FIG. 10, the apparatus 1000 comprises a processing component 1022, and further comprises one or more processors as well as a memory source represented by a memory 1032 configured to store instructions executable by the processing component 1022, such as an application program. The application program stored in the memory 1032 may comprise one or more modules, each of which corresponds to a group of instructions. In addition, the processing component 1022 is configured to execute instructions so as to execute the above embodiments of the image compression methods described above.

The apparatus 1000 may also comprise a power component 1026 configured to perform power management of the apparatus 1000, a wired or wireless network interface 1050 configured to connect the apparatus 1000 to a network, and an input/output interface 1058. The apparatus 1000 may operate an operating system stored in the memory 1032, such as Windows Server™, Mac OS X™, Unix™, Linux™, FreeBSD™ or the like.

Each module or unit discussed above for FIGS. 7-8, such as the first acquisition module, the first division module, the second division module, the second acquisition module, the quantization module, the encoding module, the first detection sub-module, the image segmentation sub-module, the converging sub-module, and the first determination sub-module may take the form of a packaged functional hardware unit designed for use with other components, a portion of a program code (e.g., software or firmware) executable by the processor 920 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. An image compression method, comprising:
acquiring an uncompressed source image;
dividing the source image into at least two regions of pixels;
dividing the source image into blocks of pixels of a preset size, and converting data in each pixel block into frequency-domain data;
determining quantization tables each corresponding to each region, wherein different quantization tables for different regions correspond to different quantization parameters;
quantizing the frequency-domain data of pixel blocks in each region by using the corresponding quantization table; and
encoding the quantized frequency-domain data to obtain a compressed image.

2. The method of claim 1,
wherein dividing the source image into at least two regions comprises determining at least one ROI (Regions Of Interest) and at least one non-ROI in the source image;
wherein determining quantization tables each corresponding to each region comprises determining at least one first type of quantization table each corresponding to each of the at least one ROI and determining at least one second type of quantization table each corresponding to each of the at least one non-ROI; and
wherein the quantization parameters of the at least one second type of quantization table are larger than the corresponding quantization parameters of the at least one first type of quantization table.

3. The method of claim 2, wherein determining the at least one ROI and the at least one non-ROI in the source image comprises:
detecting at least one salient region in the source image;
performing image segmentation on the at least one detected salient region;
filtering and converging an image segmentation result to obtain at least one candidate ROI; and
determining the at least one ROI from the at least one candidate ROI; and
determining at least one region outside the at least one ROI in the source image as the at least one non-ROI.

4. The method of claim 2, wherein determining the quantization table corresponding to each region comprises:
determining quantization parameters corresponding to high-frequency parts in each of the at least one first type of quantization tables according to values of corresponding high-frequency components of the frequency-domain data of pixel blocks of the each of the at least one ROI and a preset percentage, the preset percentage being a preset proportion that the corresponding high-frequency parts of the frequency-domain data would be quantized to non-zero values.

5. The method of claim 1, wherein dividing the source image into blocks of pixels of the preset size comprises: dividing the source image into 8-pixel by 8-pixel blocks.

6. A terminal device, comprising:
a processor; and
a memory configured to store instructions executable by the processor,
wherein the processor is configured to cause the device to:
acquire an uncompressed source image;
divide the source image into at least two regions of pixels;
divide the source image into blocks of pixels of a preset size, and convert data in each pixel block into frequency-domain data;
determining quantization tables each corresponding to each region, wherein different quantization tables correspond to different quantization parameters;
quantize the frequency-domain data of the pixel blocks in each region by using the corresponding quantization table; and
encode the quantized frequency-domain data to obtain a compressed image.

7. The terminal device of claim 6,
wherein to divide the source image into at least two regions, the processor is further configured to cause the device to determine at least one ROI and at least one non-ROI in the source image;
wherein to determine quantization tables each corresponding to each region, the processor is configured to cause the device to determine at least one first type of quantization table each corresponding to each of the at least one ROI and determine at least one second type of quantization table each corresponding to each of the at least one non-ROI; and
wherein the quantization parameters of the at least one second type of quantization table are larger than the corresponding quantization parameters of the at least one first type of quantization table.

8. The terminal device of claim 7, wherein to determine the at least one ROI and the at least one non-ROI in the source image, the processor is configured to cause the device to:
detect at least one salient region in the source image;
perform image segmentation on the at least one detected salient region;
filter and converge an image segmentation result to obtain at least one candidate ROI; and
determine the at least one ROI from the at least one candidate ROI; and
determine the at least one region outside the at least one ROI in the source image as the at least one non-ROI.

9. The terminal device of claim 7, wherein to determine the quantization table corresponding to each region, the processor configured to cause the device to:
determine quantization parameters corresponding to high-frequency parts in each of the at least one first type of quantization tables according to values of corresponding high-frequency components of the frequency-domain data of pixel blocks of the each of the at least one ROI and a preset percentage, the preset percentage being a preset proportion that the corresponding high-frequency parts of the frequency-domain data would be quantized to non-zero values.

10. The terminal device of claim 6, wherein to divide the source image into blocks of pixels of the preset size, the processor is configured to cause the device to divide the source image into 8-pixel by 8-pixel blocks.

11. A non-transitory computer-readable storage medium having stored therein instructions that, when executed by a processor of a mobile terminal, cause the mobile terminal to:
acquire an uncompressed source image;
divide the source image into at least two regions of pixels;
divide the source image into blocks of pixels of a preset size, and converting data in each pixel block into frequency-domain data;
determine quantization tables each corresponding to each region, wherein different quantization tables correspond to different quantization parameters;
quantizing the frequency-domain data of the pixel blocks in each region by using the corresponding quantization table; and
encode the quantized frequency-domain data to obtain a compressed image.

12. The storage medium of claim 11,
wherein to divide the source image into at least two regions, the instructions, when executed by the processor, cause the mobile terminal to determine at least one ROI (Region Of Interest) and at least one non-ROI in the source image;
wherein to determine quantization tables each corresponding to each region, the instructions, when executed by the processor, cause the mobile terminal to determine at least one first type of quantization table each corresponding to each of the at least one ROI and determine at least one second type of quantization table each corresponding to each of the at least one non-ROI; and
wherein the quantization parameters of the at least one second type of quantization table are larger than the corresponding quantization parameters of the at least one first type of quantization table.

13. The storage medium of claim 12, wherein to determine the at least one ROI and the at least one non-ROI in the source image, the instructions, when executed by the processor, cause the mobile terminal to:
detect at least one salient region in the source image;
perform image segmentation on the at least one detected salient region;
filter and converge an image segmentation result to obtain at least one candidate ROI; and
determine the at least one ROI from the at least one candidate ROI; and
determine the at least one region outside the at least one ROI in the source image as the at least one non-ROI.

14. The storage medium of claim 12, wherein to determine the quantization table corresponding to each region, the instructions, when executed by the processor, cause the mobile terminal to:
determine quantization parameters corresponding to high-frequency parts in each of the at least one first type of quantization tables according to values of corresponding high-frequency components of the frequency-domain data of pixel blocks of the each of the at least one ROI and a preset percentage, the preset percentage being a preset proportion that the corresponding high-frequency parts of the frequency-domain data would be quantized to non-zero values.

15. The storage medium of claim 11, wherein to divide the source image into blocks of pixels of the preset size, the instructions, when executed by the processor, cause the mobile terminal to divide the source image into 8-pixel by 8-pixel blocks.
